(19) United States
(12) Patent Application Publication
(10) Pub. No.: US 2016/0342817 A1
(43) Pub. Date: Nov. 24, 2016

(54) SYSTEM AND METHOD FOR CONTROLLING ACCESS TO PORTABLE COMPUTING DEVICES

(71) Applicant: The Code Corporation, Draper, UT (US)

(72) Inventors: John Deal, Springfield, PA (US); Garrett Russell, Phoenixville, PA (US); George Powell, Draper, UT (US); Paul Graham Timmerwilke, Fallbrook, CA (US)

(21) Appl. No.: 14/717,913

(22) Filed: May 20, 2015

(51) Int. Cl. G06F 21/88; G06F 21/32; G06F 21/31

(52) U.S. Cl. CPC G06F 21/88; G06F 21/31; G06F 21/32

(57) ABSTRACT

A system and method for controlling access to portable computing devices are disclosed. Identification information of a user is obtained and a portable computing device to be assigned to a particular user is selected from the plurality of portable computing devices. An association of the user and the selected portable computing device is recorded within a database. The selected portable computing device is then unlocked for use by the user. The portable computing devices may be secured in a multi-bay charging station with each bay including a mechanical lock which is controlled independently of the mechanical lock for each of the other bays. The checked-in portable computing device may be locked in the multi-bay charging station and the user and the checked-in portable computing device may then be dissociated.

### TECHNICAL FIELD

The present disclosure relates generally to controlling access to portable computing devices. More specifically, the present disclosure relates to electric means and mechanical means for controlling access to portable computing devices secured in a multi-bay charging station.

### BACKGROUND

Many general-purpose portable consumer devices such as iPhones, iPads, iPods, and Android-based phones, tablets, and phablets are being used in the workplace. Examples of industries that use such portable consumer devices include healthcare (hospitals and clinics), hospitality (hotels), etc. Use of these devices is becoming even more prevalent with the development of cases which add workplace-specific functionality to the device such as a barcode-reading sled and the development of decoder applications that enable the native camera within the device to be used for barcode reading.

A problem is that these devices are general-purpose consumer devices and have significant value outside of the workplace. The value of these devices and their usefulness in consumer applications create an incentive for the devices to be misappropriated. Misappropriation of such devices is a particular problem in a workplace environment where devices are shared among co-workers and accountability for securing the device is not assigned to any particular individual.

### SUMMARY

A first aspect of the present disclosure comprises a method for controlling access to each of a plurality of portable computing devices and assigning responsibility for security of a portable computing device to a particular authorized user.

The method may comprise: i) obtaining identification information of a user; ii) selecting a portable computing device from the plurality of portable computing devices and recording an association of the user and the selected portable computing device within a database; and iii) unlocking the selected portable computing device.

Unlocking the selected portable computing device may comprise unlocking a mechanical lock which secures the selected portable computing device within a bay of a multi-bay charging station. Each bay of the multi-bay charging station may include a mechanical lock which is controlled independently of the mechanical lock for each of the other bays.

The identification information of the user may be obtained by reading a character string unique to the user from a barcode on an identification card of the user. Alternatively, the identification information of the user may be obtained by a radio frequency identity (RF ID) reader reading a character string unique to the user from an RF ID access device of the user. Alternatively, the identification information of the user may be a user identification character string and/or passcode entered by the user. Alternatively, the identification information of the user may be a biometric characteristic unique to the user which is obtained by reading or measuring the unique biometric characteristic of the user.

The method may further comprise: i) determining an identification of a checked-in portable computing device being returned to one of the bays of the multi-bay charging station; ii) locking the checked-in portable computing device within the bay to which the portable computing device is being returned; and iii) performing one of: a) recording an indication that the portable computing device has been checked in; or b) recording a dissociation of the user and the checked-in portable computing device. In each case, the authorized user is released from responsibility for security of the checked-in portable computing device.

The identification of the checked-in portable computing device may be determined by reading or obtaining a device ID from the checked-in portable computing device via a power/data connector through which the checked-in portable computing device is charged. Alternatively, the identification of the checked-in portable computing device may be determined by receiving a device ID from the checked-in portable computing device via a radio frequency (RF) interface.

The method may further comprise: i) sending the identification information from a first system which obtains the identification of the user to a remote authorization controller via a network which interconnects the first system which obtains the identification of the user and the remote authorization controller, wherein an authorization signal is generated by the remote authorization controller based on the identification information of the user; and ii) unlocking the selected portable computing device in response to receiving the authorization signal from the remote authorization controller.

The method may further comprise: i) determining an identification of a checked-in portable computing device being returned to one of the bays of the multi-bay charging station; ii) locking the checked-in portable computing device within the bay to which the portable computing device is being returned; and iii) sending identification of the checked-in portable computing device to the remote authorization controller via the network.

Another aspect of the present disclosure comprises an apparatus for controlling access to each of a plurality of portable computing devices and assigning responsibility for security of a portable computing device to a particular authorized user. The apparatus may comprise: i) an identification information reader for obtaining identification information of a user; ii) a controller for selecting a portable computing device from the plurality of portable computing devices and recording an association of the user and the selected portable computing device within a database; and iii) a locking mechanism for locking each of the plurality of portable computing devices and unlocking the selected portable computing device for use by the authorized user in response to the controller providing an authorization signal.

The locking mechanism may be a multi-bay charging station with each bay including a mechanical lock which is controlled independently of the mechanical lock for each of the other bays.

The identification information reader may be a barcode reader and the identification information of the user may be obtained by reading a character string unique to the user from a barcode on an identification card of the user. Alternatively, the identification information reader may be an RF ID reader interrogating an RF ID access device and the identification information of the user may be a character string unique to the user which is obtained by a radio frequency identity (RF ID) from an RF ID access device of the user. Alternatively, the identification information reader may be a mechanical keypad or electronic (virtual) keypad implemented as a touchscreen display and the identification information of the user may be a user identification character string and/or passcode entered by the user. Alternatively, the identification information reader may be a biometric reader and the identification information of the user may be a biometric characteristic of the user obtained by reading or measuring that biometric characteristic of the user.

The apparatus may be further configured to: i) determine an identification of a checked-in portable computing device being returned to one of the bays of the multi-bay charging station; ii) lock the checked-in portable computing device within the bay to which the checked-in portable computing device is returned; and iii) perform one of: a) record an indication that the portable computing device has been checked in; or b) record a dissociation of the user and the checked-in portable computing device. In each case, the authorized user is released from responsibility for the security of the checked-in portable computing device.

The apparatus may be configured to determine the identification of the checked-in portable computing device by reading a device ID via a power/data connector through which the checked-in portable computing device is charged. Alternatively, the apparatus may be configured to determine the identification of the checked-in portable computing device by receiving a device ID from the checked-in portable computing device via a radio frequency (RF) interface.

The identification information reader may be embodied in a first system which further includes a communication interface communicatively coupling the identification information reader to the controller via a network. In this embodiment, the controller may be configured to receive an authorization request message comprising the identification information of the user and provide an authorization response message. The locking mechanism may be configured to unlock the selected portable computing device in response to the authorization response message.

The apparatus may further comprise, within each bay of the multi-bay charging station, an ultraviolet light for sterilizing the checked-in portable computing device. In this embodiment, the ultraviolet light is activated to sterilize the checked-in portable computing device upon it being returned to the bay of the multi-bay charging station.

Another aspect of the present disclosure comprises a portable computing device. The portable computing device may comprise an identification information reader for obtaining user identification information identifying a user and a network interface for: i) sending an authorization request to a remote server, the authorization request comprising identification of the portable computing device and the user identification information; and ii) receiving an authorization response from the remote server. A controller may unlock the portable computing device based on the authorization response received from the remote server.

In one embodiment, unlocking the portable computing device may comprise sending an unlock signal to a mechanical device securing the portable computing device whereby the mechanical device mechanically releases the portable computing device in response to the unlock signal.

In another embodiment, the authorization response may include an authorization code and unlocking the portable computing device may comprise input of the authorization code to an electronic locking system of the portable computing device, and the electronic locking system unlocks the portable computing device to enable use only if the authorization code is a valid authorization code.

In yet another embodiment, the controller may be further configured to lock the portable computing device if it is moved beyond a limited area in which the user is authorized to operate the portable computing device.

### BRIEF DESCRIPTION OF THE DRAWINGS

FIG. 1 depicts a system for controlling access to each of a plurality of portable computing devices in accordance with one embodiment of the present disclosure.

FIG. 2 depicts a portable computing device within a charging bay in accordance with one embodiment of the present disclosure.

FIG. 3 depicts a multi-bay charging station in accordance with an embodiment of the present disclosure.

FIG. 4 depicts a multi-bay charging station in accordance with an embodiment of the present disclosure.

FIGS. 5A-5E depict exemplary identification information capture systems in accordance with certain embodiments of the present disclosure.

FIG. 6 is a flow chart depicting operation of exemplary aspects of the present disclosure.

FIG. 7 is a diagram depicting a database in accordance with an embodiment of the present disclosure.

FIG. 8 is a flow chart depicting operation of exemplary aspects of the present disclosure.

FIG. 9 is a flow chart depicting operation of exemplary aspects of the present disclosure.

### DETAILED DESCRIPTION

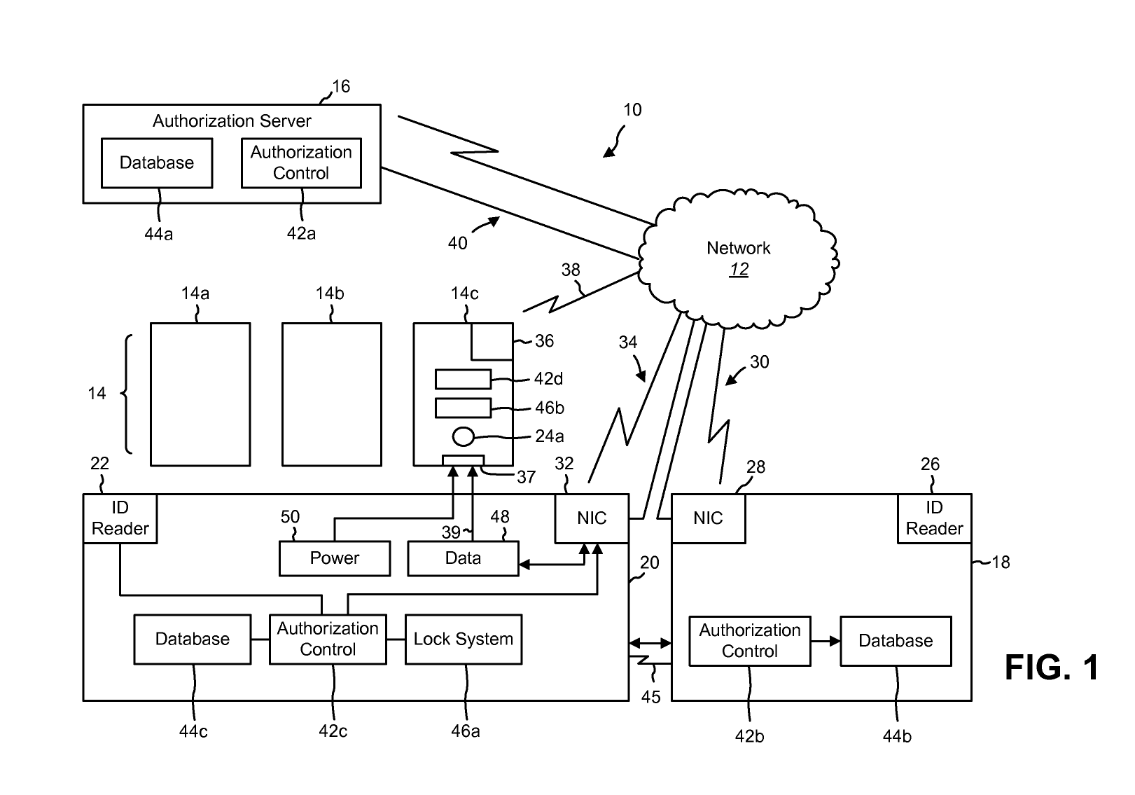

FIG. 1 depicts a system 10 for controlling access to each of a plurality of portable computing devices 14a, 14b, 14c in accordance with one embodiment of the present disclosure. Each portable computing device may be a general-purpose consumer device such as an iPhone, iPod, iPad, or Android- or other operating system-based phone, tablet, or phablet, or any of the devices described in U.S. patent application Ser. No. 14/527,594 filed on Oct. 29, 2014, entitled “Improving The Barcode-Reading Capabilities of a Portable, Hand-Held Computing Device That Comprises a Camera,” including any of such devices within, or inclusive of, a case or sled which adds workplace functionality to such device. The contents of patent application Ser. No. 14/527,594 are hereby incorporated by reference in their entirety.

In an exemplary embodiment, the system 10 may comprise a multi-bay charging station 20, a freestanding user identification information reader system 18 (which may alternatively be referred to as a standalone user identification information reader system 18), and/or an authorization server 16, each of which may be interconnected to the other components and/or each of the plurality of portable computing devices 14a, 14b, 14c via a communication network 12.

The communication network 12 may be compatible with any network protocol including, but not limited to, wired and/or wireless TCP/IP protocols such as IEEE 802.11 and various wide area wireless network protocols such as Wideband Code Division Multiple Access (WCDMA), High Speed Packet Access (HSPA), cdma2000, Long Term Evolution (LTE), or the like.

The authorization server 16 may maintain a wired or wireless link 40 with the network 12 for communication with any of: i) the freestanding user identification information reader system 18; ii) the multi-bay charging station 20; and/or iii) at least one of the portable computing devices 14a, 14b, 14c.

The freestanding user identification information reader system 18 may include a network interface system 28 (e.g., a network interface card (NIC)) which implements a wired or wireless link 30 between the freestanding user identification information reader system 18 and the network 12 for communication with any of: i) the multi-bay charging station 20; ii) the authorization server 16; and/or iii) any of the portable computing devices 14.

The multi-bay charging station 20 may include a network interface system 32 (e.g., an NIC) which implements a wired or wireless link 34 between the multi-bay charging station 20 and the network 12 for communication with any of: i) the freestanding user identification information reader system 18; ii) the authorization server 16; and/or iii) any of the portable computing devices 14.

The multi-bay charging station 20 and the freestanding user identification information reader system 18 may further be communicatively connected by a wired or wireless point-to-point communication link 45, enabling communication between the freestanding user identification information reader system 18 and the wired or wireless point-to-point communication link 45. The point-to-point communication link 45 may be compatible with the following technologies: Universal Serial Bus (USB), serial Universal Asynchronous Receiver/Transmitter (UART), Bluetooth, or other wired or wireless point-to-point communication technologies.

Each portable computing device 14 may include a network interface system 36 which implements a wireless (or wired) link 38 between the portable computing device 14 and the network 12 for communication with any of: i) the freestanding user identification information reader system 18; ii) the authorization server 16; and/or iii) the multi-bay charging station 20. Further, each portable computing device 14 may include a power/data connector 37 which implements a data link 39 with a data interface 48 of the multi-bay charging station 20 which, among other functions, enables the portable computing device 14 to communicate with any of: i) the multi-bay charging station 20, ii) the freestanding user identification information reader system 18 (utilizing the network interface system 32 of the multi-bay charging station 20 and the network 12 or the point-to-point communication link 45); or iii) and the authorization server 16 (utilizing the network interface system 32 of the multi-bay charging station 20 and the network 12). The portable computing devices 14 may be recharged through the power/data connector 37 by the power interface 50 of the multi-bay charging station 20.

The system 10 includes at least one identification information reader 22, 24, 26 which is used to identify an authorized user to which at least one of the portable computing devices 14a, 14b, or 14c will be checked out (unlocked) for use by the authorized user.

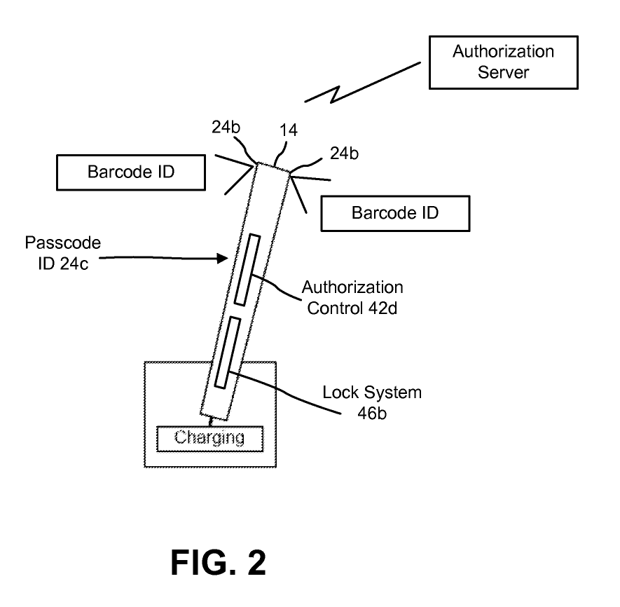

The at least one identification information reader 22, 24, 26 may be embodied as any of: i) an identification information reader 22 embodied within the multi-bay charging station 20; ii) an identification information reader 26 embodied in a freestanding user identification information reader system 18; iii) an identification information reader 24a embodied as a fingerprint reader within at least one of the portable computing devices 14a, 14b, and 14c; iv) an identification information reader 24b (shown in FIG. 2) embodied as a front- or rear-facing camera within the at least one of the portable computing device 14a, 14b, and 14c, or any camera or other input means within a case or accessory associated with, or secured to, the portable computing device 14a, 14b and 14c (i.e., the portable computing device 14 may scan or read a barcode presented in the field of view of the camera while docked in the charging station 20 as shown in FIG. 2); and v) an identification information reader 24c (shown in FIG. 2) embodied as the touch screen user interface of the at least one of the portable computing devices 14a, 14b, and 14c.

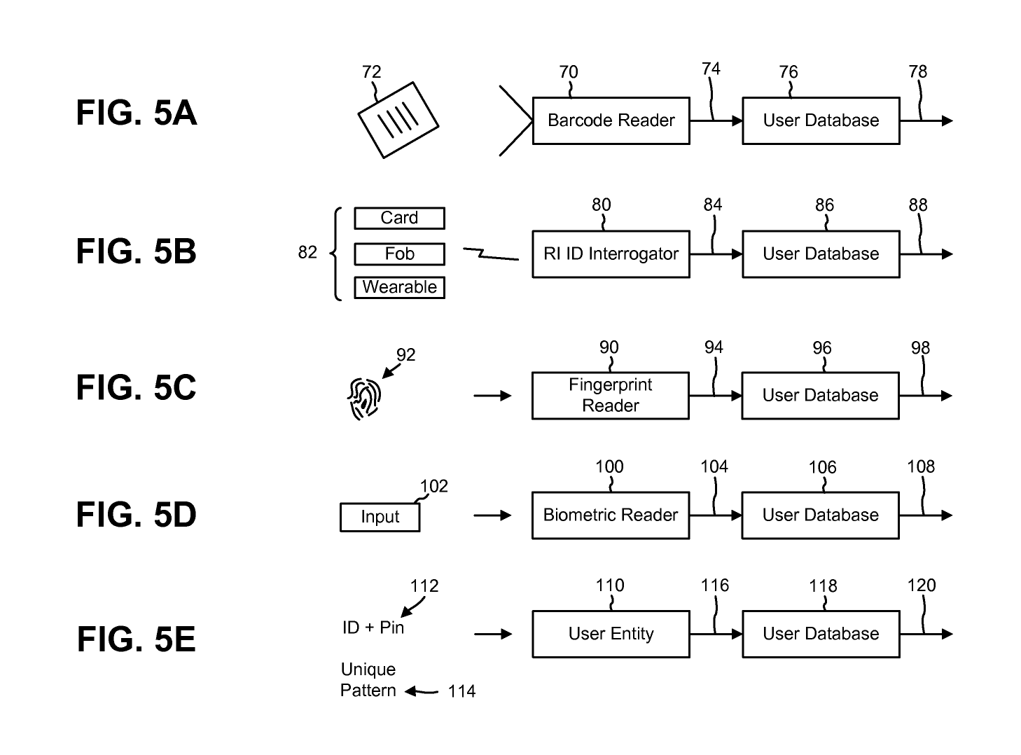

Turning to FIGS. 5A, 5B, 5C, 5D, and 5E, permutations of embodiments of the identification information readers 22, 24, and 26 implemented in any of the multi-bay charging station 20, the freestanding user identification information reader system 18, and/or at least one of the plurality of portable computing devices 14a, 14b, 14c are explained.

FIG. 5A depicts a barcode reader 70 which reads a barcode 72 which may be a barcode on an authorized user's ID card. The barcode 72 includes a character string which is an identification value unique to one of the authorized users. For example, the identification value may be a serial number of the ID card (i.e., each ID card has a unique serial number) or it may be an employee ID number encoded into the barcode. The identification value 74 unique to one of the authorized users is output by the barcode reader 70. The user database 76 is an optional structure that may be used to map the identification value 74 to a different unique value associated with the authorized user. For example, if the identification value encoded into the barcode 72 is the serial number of an ID card, the user database 76 may map that identification value to the user ID number of the authorized user to which that ID card has been assigned. The identification information 78 of the user that is output to the authorization control module 42 (discussed herein) may be either the unique identification value 74 decoded from the barcode (e.g., a User ID or ID card serial number) or the identification information 78 (e.g., a User ID) obtained by mapping the identification value 74 decoded from the barcode (e.g., an ID card serial number) by the user database 76. Implementation of a barcode reader as an identification information reader is useful in the identification information reader 22, the identification information reader 26, and the identification information reader 24b implemented utilizing a front- or rear-facing camera of at least one of the portable computing devices 14a, 14b, and 14c.

FIG. 5B depicts an RF ID interrogator 80 which obtains a response value from an RF ID device 82 such as an RF ID card, and RF ID FOB, or any RF ID response systems embodied in wearable devices such as a ring. The response value may be the unique serial number of the RF ID device 82. The response value 84 is output by the RF ID interrogator 80. A user database 86 is an optional structure that may be used to map the response value 84 to a different unique value associated with the authorized user, such as the user's User ID. The identification information of the user 88 that is output to the authorization control module 42 (discussed herein) may be either the response value 84 or the different unique value associated with the authorized user (e.g., a User ID) obtained by mapping the response value 84 (e.g., a serial number) to the unique value (e.g., a User ID) by the user database 86. Implementation of an RF ID interrogator 80 as an identification information reader is useful in the identification information reader 22 and the identification information reader 26.

FIG. 5C depicts a fingerprint reader 90 as an example form of a biometric reader, which captures the unique pattern of an authorized user's fingerprint 92 and outputs characteristics 94 of that unique pattern to a user database 96. The user database 96 utilizes the characteristics 94 to obtain identification information 98 of the user and outputs the identification information 98 of the user to the authorization control module 42 (discussed herein). Implementation of a fingerprint reader as an identification information reader is useful in the identification information reader 22, the identification information reader 26, and the identification information reader 24a implemented as a fingerprint reader within at least one of the portable computing devices 14a, 14b, and 14c.

FIG. 5D depicts a generic biometric reader 100 which reads, measures, or captures one or more biometric characteristics 102 unique to the authorized user and outputs an indication 104 of the one or more characteristics to a user database 106. The user database 106 utilizes the indication 104 of the one or more characteristics to obtain identification information 108 of the user and outputs the identification information 108 of the user to the authorization control module 42 (discussed herein). Implementation of such a biometric reader as an identification information reader is useful in the identification information reader 22 and the identification information reader 26.

FIG. 5E depicts a user entry device such as a mechanical keypad or a touchscreen overlaying a display which obtains an input unique to the user such as a unique user ID or a personal identification number (PIN) number 112 (e.g., a mechanical keypad or a virtual keypad implemented on the touchscreen overlaying the display) or a unique pattern of taps and/or strokes entered on the touchscreen 114 (for example, the user's signature). The user entry device 110 outputs the captured information 116. An optional user database 118 may be used to map the captured information 116 to a different unique value associated with the authorized user. For example, the captured information 116 may be a signature and the user database 118 may use the signature as input and provide the unique user's User ID of the person associated with that signature. The identification information of the user 120 that is output to the authorization control module 42 (discussed herein) may be either the captured information 116 or the unique value (e.g., a User ID) generated by the user database 118. Implementation of a user entry device as an identification information reader is useful in the identification information reader 22, the identification information reader 26, and the identification information reader 24c implemented as the touchscreen of at least one of the portable computing devices 14a, 14b, and 14c.

Returning to FIG. 1, the system 10 further includes at least one authorization control module 42 which receives the identification information about the user and: i) determines which of the plurality of portable computing devices 14a, 14b, or 14c (i.e., the selected portable computing device) will be unlocked for use by the authorized user; ii) records, in at least one database 44, a record associating a user ID of the authorized user, a device ID of the selected portable computing device, and/or the date/time the selected portable computing device is unlocked for use by the authorized user; and iii) generates an authorization signal to unlock the selected portable computing device. This process assigns responsibility for securing the selected portable computing device to the authorized user.

The at least one authorization control module 42 may be implemented as: i) an authorization control module 42a within the authorization server 16; ii) an authorization control module 42b implemented within the freestanding user identification information reader system 18; iii) an authorization control module 42c implemented within the multi-bay charging station 20; and/or iv) an authorization control module 42d implemented within a least one of the portable computing devices 14a, 14b, and 14c.

The at least one database 44 may be implemented as: i) database 44a within the authorization server 16; ii) database 44b implemented within the freestanding user identification information reader system 18; and/or iii) database 44c implemented within the multi-bay charging station 20. A more detailed discussion of the authorization control module 42 and the database 44 is included herein.

The system 10 further includes a least one locking system which may be implemented as: i) a mechanical locking system implemented in the multi-bay charging station 20 which prevents removal of each portable computing device 14a, 14b, and 14c until such time that authorization to unlock has been generated by the authorization control module 42; and/or ii) an electronic locking system implemented in at least one of the portable computing devices 14a, 14b and 14c which prevents use of the device (e.g., the device remains disabled) until such time that authorization to unlock has been generated by the authorization control module 42.

In a case where the portable computing device 14 receives an authorization response from a remote authorization control module, the portable computing device 14 may send an unlock signal to a mechanical device (e.g., the multi-bay charging station 20), securing the portable computing device 14 whereby the mechanical device may mechanically release the portable computing device 14 in response to the unlock signal.

In another embodiment, the authorization response that the portable computing device 14 receives may include an authorization code and the portable computing device 14 may be unlocked by inputting the authorization code to an electronic locking system of the portable computing device 14. The electronic locking system may unlock the portable computing device 14 to enable use if the entered authorization code is a valid authorization code.

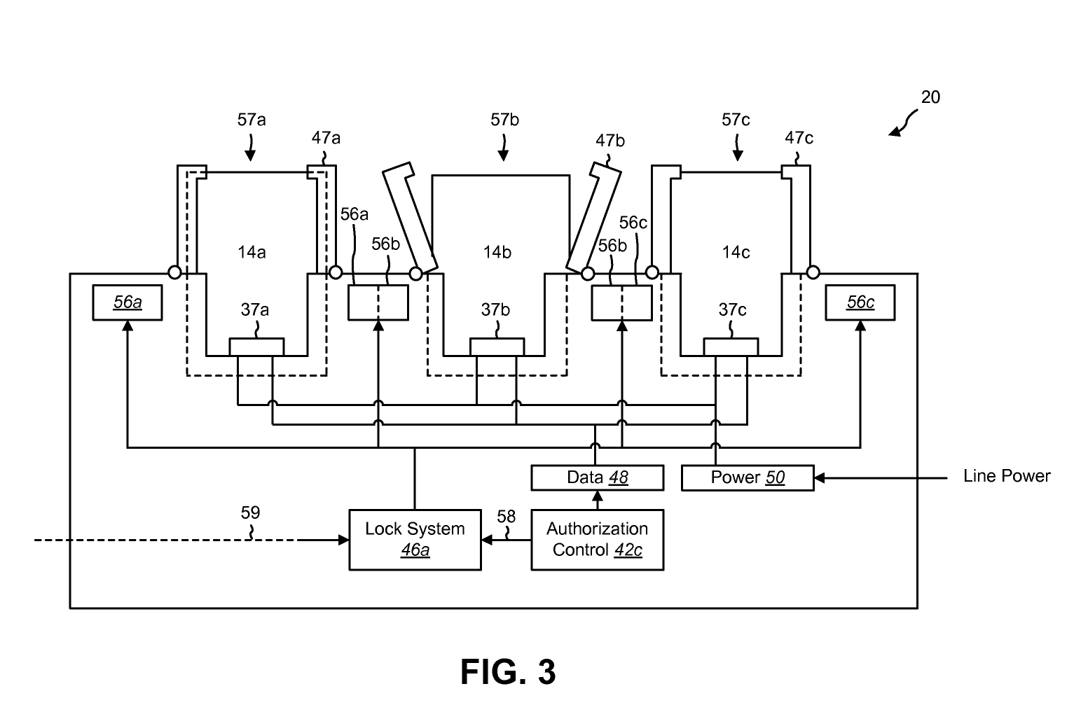

FIG. 3 depicts the multi-bay charging station 20 embodied as an array of locking charging bays implemented as charging cradles 57a, 57b, and 57c, with each charging cradle 57a, 57b, 57c including a mechanical lock 47a, 47b, and 47c associated therewith and which secures a portable computing device 14 within the charging cradle 57a, 57b, and 57c until such time as the mechanical lock is released.

For clarity, mechanical locks 47a and 47c are depicted in a locked position wherein portable computing devices 14a and 14c are physically restrained from being removed from the charging cradle 57a and 57c. Mechanical lock 47b is depicted in a released position such that portable computing device 14b may be removed from the charging cradle 57b without physical restraint by mechanical lock 47b.

The locking system of the embodiment includes a locking control module 46a and the mechanical locks 47a, 47b, and 47c, each of which is associated with a charging bay and each of which is coupled to an independent actuator 56a, 56b, and 56c such that each mechanical lock 47a, 47b, and 47c can be independently toggled between its locked position and its released position

In operation, the locking control module 46a may receive an authorization signal 58 from an internal authorization control module 42c or an authorization signal 58 embodied as an authorization response 59 from a remote authorization control module 42a, 42b, or 42d via the network interface system 32 and the network 12 or the point-to-point communication link 45.

In response to an authorization signal 58, the locking control module 46a actuates (e.g., provides actuation power to) the actuator 56a, 56b, or 56c associated with the charging cradle 57a, 57b, 57c in which the selected portable computing device 14 to be unlocked is positioned. Actuating the actuator 56a, 56b, or 56c has the result of toggling the mechanical lock 47a, 47b, or 47c to its released position such that the user may remove the unlocked portable computing device 14 from its charging bay.

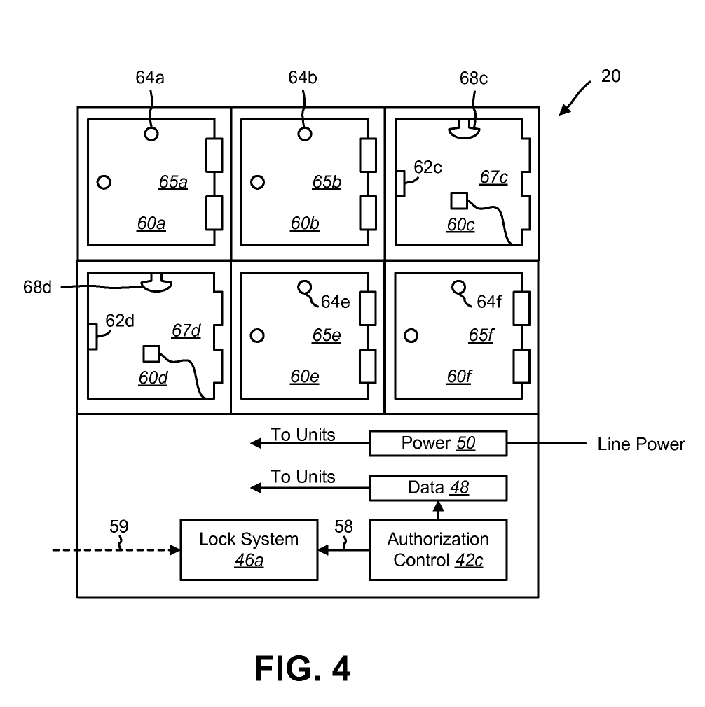

FIG. 4 depicts the multi-bay charging station 20 embodied as an array of locking compartments 60a-f (e.g., lockers), with each charging bay being a locking compartment 60a-f having a mechanically locking door 65a-f to secure a portable computing device 14 within the locking compartment 60a-f.

Locking compartments 60c and 60d are depicted with locking doors removed to show components within the interior 67c and 67d of the locking compartments 60c and 60d. Within the interior of the locking compartments 60a-f may be: i) an electrical cord with a connector 69a-f which couples to the power/data connector 37 of a portable computing device 14 for charging power to the portable computing device 14; and ii) a communication connection between the portable computing device 14 and the data interface 48 within the multi-bay charging station 20.

Similar to the embodiment of FIG. 3, the multi-bay charging station 20 includes a locking control module 46a, and a mechanical securing mechanism 62 (e.g., a door lock actuator) associated with each locking compartment 60a-f. Door lock actuators 62c and 62d are depicted in FIG. 4 for locking compartments 60c and 60d, and door lock actuators for locking compartments 60a, 60b, 60e, 60f are positioned behind doors 65a, 65b, 65e, and 65f. In operation, in response to an authorization signal 58 from an authorization control module 42c or an authorization response 59 from a remote authorization control module 42a, 42b, 42d, the locking control module 46a actuates the door lock actuator 62 associated with the locking compartment 60a-f in which the portable computing device 14 to be unlocked is secured. Actuating the door lock 62 unlocks the door such that the user may remove the unlocked portable computing device 14 from its locking compartment 60a-f. To enable the user to more quickly determine which locking compartment 60a-f has been unlocked, each locking compartment 60a-f may have an indicator light 64 and the locking control module 46a may illuminate the indicator light 64 associated with the locking compartment 60a-f that is being unlocked. Indicator lights 64a, 64b, 64e, and 64f are depicted in FIG. 4 for locking compartments 60a, 60b, 60e, and 60f. In embodiments where the portable computing devices 14a, 14b and 14c are visible within each bay of a multi-bay charging station 20, the display screen or other visible indicator on the selected portable computing device itself may be illuminated or activated to indicate to the user which of the portable computing devices 14a, 14b, 14c is the selected portable computing device being unlocked.

Further, in some embodiments, each locking compartment 60a-f may include a sterilization system 68 such as an ultra-violate illumination source that is activated for a predetermined period of time to sterilize a portable computing device 14 within the locking compartment 60a-f. Sterilization systems 68c and 68d are depicted in FIG. 4 in the locking compartments 60c and 60d with doors removed and sterilization systems for locking compartments 60a, 60b, 60e, and 60f would be behind doors 65a, 65b, 65e and 65f. As will be discussed in more detail below, each sterilization system 68 is activated when a portable computing device 14 is checked in or returned to the multi-bay charging station 20.

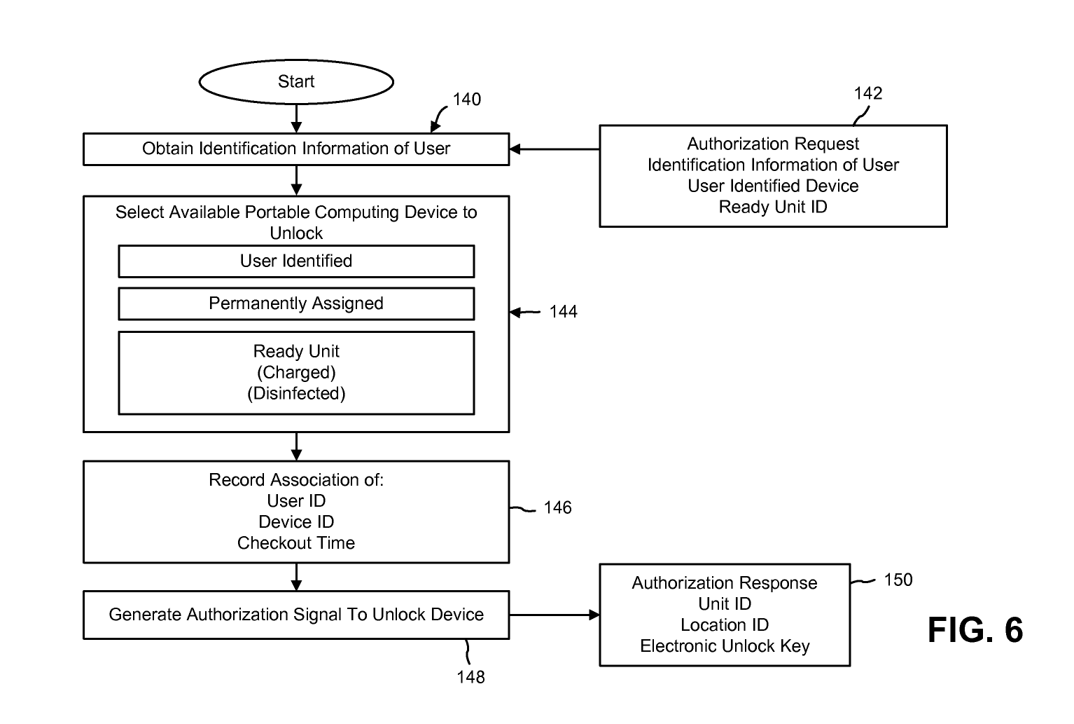

FIG. 6 depicts a flow chart showing exemplary operation of the authorization control module 42 in relation to its function of recording checkout of a portable computing device 14. Step 140 represents obtaining the identification information of the user which is captured by the identification information reader 22, 24, or 26 and output to the authorization control module 42 as described in relation to FIGS. 5A through 5E. In embodiments where the authorization control module 42 and the identification information reader 22, 24, or 26 are operated by the same processor, step 140 may be accomplished utilizing an internal processing call.

Examples of when both the authorization control module 42 and the identification information reader 22, 24, or 26 are operated by the same processor include: i) when both the identification information reader 22 and the authorization control module 42c within the multi-bay charging station 20 are controlled by the same processer within the multi-bay charging station 20; ii) when the identification information reader 26 and the authorization control module 42b within the freestanding user identification information reader system 18 are controlled by the same processor within the freestanding user identification information reader system 18; or iii) when the identification information reader 24a, 24b, or 24c and the authorization control module 42d within a portable computing device 14 are controlled by the processor of the portable computing device 14.

When the authorization control module 42 is separate from the identification information reader 22, 24, 26 which provides the identification information of the user, step 140 may comprise obtaining an authorization request message 142 from the device in which the identification information reader 22, 24, 26 is embodied. The authorization request message 142 may include the identification information of the user and be sent between the devices via one of, or a combination of, the network 12, the point-to-point communication link 45, and/or the data link 48 supporting data communication with the portable computing device 14 through its power/data connector 37.

In embodiments where an authorization request message is sent from a device comprising an identification information reader 22, 24, 26 to a device comprising the authorization control module 42, the authorization request message 142 may further include an identification of the portable computing device the user is requesting to unlock and/or identification of one or more of the portable computing devices 14 that are available to be checked out (e.g., that are fully charged and/or the sterilization cycle is complete).

Step 144 represents selecting one of the plurality of available portable computing devices 14 to unlock (e.g., the selected portable computing device 14). In one embodiment, selecting one of the plurality of available portable computing devices 14 may comprise determining which one of the available portable computing devices 14 the authorized user has selected for use. For example, if the user utilizes the touch screen user interface of a portable computing device 14 to enter user identification information or uses the front- or rear-facing camera of a portable computing device 14 to capture user identification information then that portable computing device 14 may be the selected portable computing device. In the event that a multi-bay charging station 20 includes hardware and/or software means for obtaining user selection of one of the portable computing devices 14 therein, that portable computing device may be the selected portable computing device. Similarly, in the event that a multi-bay charging station 20 includes means for obtaining user selection of one of the locking compartments 60a-f or charging cradles 57a-c, the portable computing device 14 within the selected locking compartment 60a-f or the charging cradle 57a-c may be the selected portable computing device.

In another embodiment, selecting one of the plurality of available portable computing devices 14 may comprise determining which one of the available portable computing device 14 has been assigned for use by the authorized user on a permanent, semi-permanent, or long term (e.g., multi-work shift) basis. In this embodiment, the authorization control module 42, after obtaining identification information of the user, may query a database to obtain one of: the device ID of the portable computing device 14 that has been assigned to the user; or ii) the location (e.g., the identification of the locking compartment 60a-f or the charging cradle 57a-c) in which the portable computing device 14 that has been assigned to the user is positioned.

In yet another embodiment, selecting one of the plurality of available portable computing devices 14 may comprise determining which portable computing devices 14 are available for checkout and selecting one of the available portable computing devices 14 at random or utilizing predetermined criteria. The portable computing devices 14 that are determined to be available for checkout may be those portable computing devices 14 that: i) are charged above a selected threshold (e.g., are fully charged); and/or ii) have completed sterilization. Determining which portable computing devices 14 are charged above a selected threshold may be determined by calculating charging time for a portable computing device 14 (i.e., the time since the portable computing device 14 began charging) or by receiving from the multi-bay charging station 20 an indication that the portable computing device 14 has completed its charging cycle.

Similarly, determining which portable computing devices 14 have completed sterilization may be determined by calculating sterilization time for a portable computing device 14 (e.g., the time since the portable computing device 14 began sterilization) or by receiving from the multi-bay charging station 20 an indication that the portable computing device 14 has completed sterilization.

Step 146 represents recording, in a database 44, an association of the user identification of the authorized user, device identification of the selected portable computing device 14 to be unlocked, and/or an identification of the date and time the selected portable computing device 14 is unlocked for use.

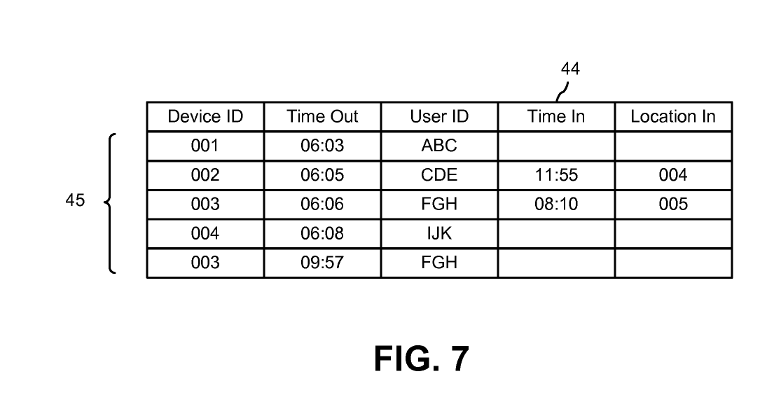

Turning briefly to FIG. 7, the database 44 may include a plurality of records 47 and each record may, when written to the database 44, associate: the device identification of the selected portable computing device 14, the date and/or time of unlocking, the user identification of the authorized user, the date and/or time the portable computing device 14 is returned to the multi-bay charging station 20 or otherwise checked-in (i.e., use is discontinued), and/or the location (e.g., the locking compartment 60a-f or the charging cradle 57a-c) to which the portable computing device 14 is returned.

Returning to FIG. 6, step 148 represents generating an authorization signal to unlock the selected portable computing device 14. In embodiments where the authorization control module 42 and the locking control module 46 are operated by the same processor, step 148 may be accomplished utilizing an internal processing call.

Examples of when both the authorization control module 42 and the locking control module 46 are operated by the same processor include: i) when the locking control module 46a and the authorization control module 42c within the multi-bay charging station 20 are controlled by the same processer within the multi-bay charging station 20; and ii) when the locking control module 46b and the authorization control module 42d within a portable computing device 14 are controlled by the processor of the portable computing device 14.

When the authorization control module 42 is separate from the locking control module 46, step 148 may comprise generating an authorization response 150 and providing the authorization response 150 to the locking control module 46 controlling the unlocking of the selected portable computing device 14. The authorization response 150 may, if sent to the locking control module 46a within a multi-bay charging station 20, comprise the authorization signal and may further include: i) identification of the selected portable computing device 14 to unlock; and ii) identification of the location (e.g., locking compartment 60a-f or charging cradle 57a-c) in which the selected portable computing device 14 is positioned

The authorization response 150 may, if sent to the locking control module 46b within the selected portable computing device 14, comprise an electronic key (e.g., an encrypted electronic key value) that the locking control module 46b utilizes as a trusted authorization signal to enable use of the portable computing device 14.

The authorization response 150 may be sent to the applicable locking control module 46 via one of, or a combination of, the network 12, the point-to-point communication link 45 and/or the data link 48 supporting data communication with the portable computing device 14 through its power/data connector 37.

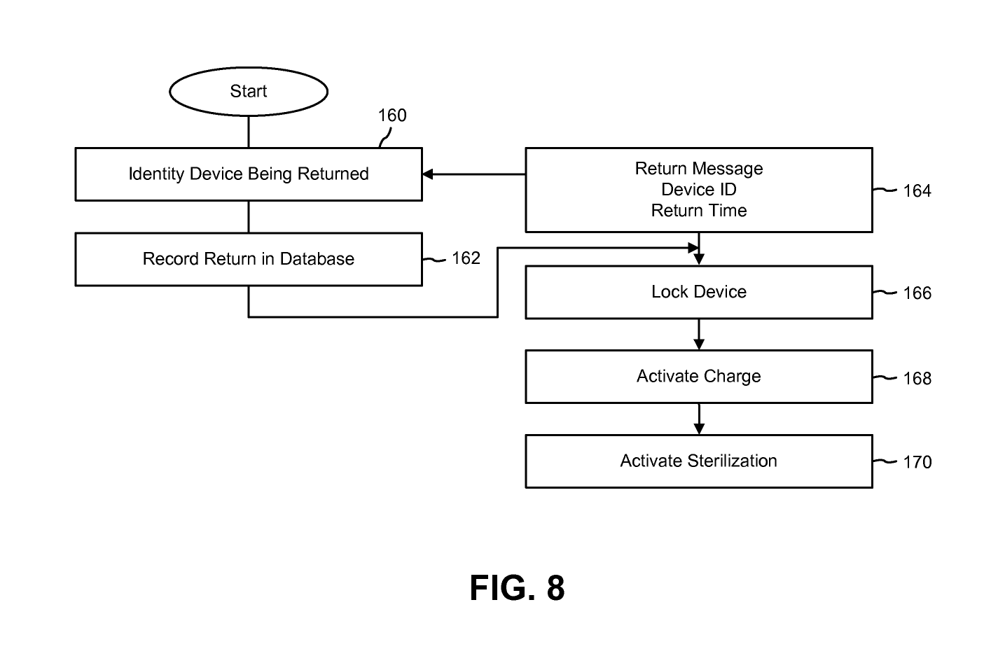

FIG. 8 depicts a flow chart showing exemplary operation of the authorization control modules 42 and the locking control module 46 in relation to their functions of recording check-in of a portable computing device 14.

Step 160 represents identifying the portable computing device 14 being checked-in. In an embodiment where the portable computing device 14 is being returned to a multi-bay charging station 20 for locking within a locking compartment 60a-f or a charging cradle 57a-c, step 160 may comprise reading the device identification of the portable computing device 14 being returned, for example, through its power/data connector 37.

In an embodiment where the portable computing device 14 being checked in is electronically locked by the locking control module 46b within the portable computing device 14, step 160 may comprise reading the device identification from a register within the portable computing device 14.

In embodiments where the authorization control module 42 is separate from the locking control module 46a or 46b which locks the portable computing device 14, step 160 may include receiving, by the authorization control module 42 from the locking control module 46a or 46b, a return message. The return message 164 may include an identification of the device being returned and an indication of the date and time the device is being returned.

The return message 164 may be sent to the authorization control module 42 via one of, or a combination of, the network 12, the point-to-point communication link 45, and/or the data link 48 supporting data communication with the portable computing device 14 through its power/data connector 37.

Step 162 represents the authorization control module 42 recording the return of the portable computing device 14 in the database 44 which, referring briefly to FIG. 7, may include writing an indication of the date and time of the return to the record 45 within the database which records the check-out information. Further, when the portable computing device 14 is being returned to a locking compartment 60a-f or a charging cradle 57a-c of a multi-bay charging station 20, step 162 may further include writing the location (e.g., an identification of the locking compartment 60a-f or the charging cradle 57a-c) which is locking the checked-in portable computing device.

Step 166 represents locking the portable computing device: i) by the locking control module 46a mechanically locking the portable computing device 14 within a locking compartment 60a-f or a charging cradle 57a-c; or ii) by the locking control module 46b electronically locking the portable computing device 14.

Step 168 represents activating charging of the checked in portable computing device and may include measuring at least one charge parameter that may be used for subsequently determining whether the portable computing device is sufficiently charged to be considered an available portable computing device (e.g., step 144 of FIG. 6).

Step 170 represents activating the sterilization system 68 for the locking compartment 60a-f in which the checked-in portable computing device is returned for sterilization of the device and may include measuring at least one sterilization parameter (such as the time required for sterilization) that may be used for subsequently determining whether the portable computing device is sufficiently disinfected to be considered an available portable computing device (e.g., step 144 of FIG. 6).

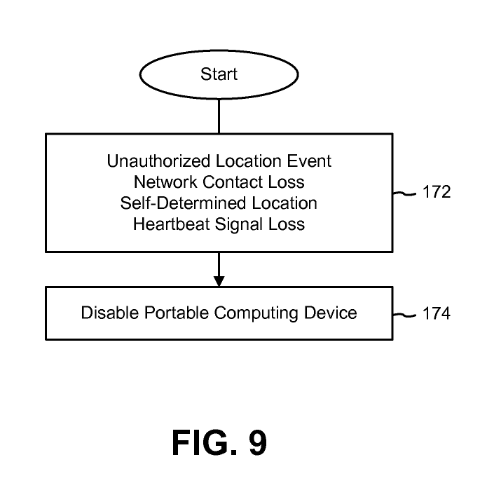

The flow chart depicted in FIG. 9 represents a further aspect of the present disclosure that may be implemented within the locking control module 46b embodied within a portable computing device 14.

Step 172 represents determining that an unauthorized location event has occurred. The systems of the portable computing device 14 may continually, on a trigger basis or on a periodic basis, monitor for the occurrence of an unauthorized location event. Examples of determining that an unauthorized location event has occurred include: i) losing communication contact with a local area network (e.g., the communication range of the local area network defines the authorized locations); ii) determining that a self-determined location (e.g., determined by Global Positioning System (GPS), network positioning, or the like) is outside of defined authorized locations; and iii) determining that a periodic authorization signal (e.g., a heartbeat signal) sent by a remote source when the portable computing device is within the authorized location has not been timely received.

Step 174 represents electronically locking or otherwise disabling use of the portable computing device 14 in response to determining that an unauthorized location event has occurred.

One or more of the features, functions, procedures, operations, components, elements, structures, etc. described in connection with any one of the configurations described herein may be combined with one or more of the functions, procedures, operations, components, elements, structures, etc. described in connection with any of the other configurations described herein, where compatible.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The claims are not limited to the specific implementations described above. Various modifications, changes and variations may be made in the arrangement, operation and details of the implementations described herein without departing from the scope of the claims

What is claimed is:

1. A method for controlling access to each of a plurality of portable computing devices, the method comprising:
obtaining identification information of a user;
selecting a portable computing device from the plurality of portable computing devices and recording an association of the user and the selected portable computing device within a database; and
unlocking the selected portable computing device.

2. The method of claim 1, wherein unlocking the selected portable computing device comprises unlocking a mechanical lock which secures the selected portable computing device within a bay of a multi-bay charging station with each bay including a mechanical lock which is controlled independently of the mechanical lock for each of the other bays.

3. The method of claim 2, wherein the identification information is obtained by reading a barcode on an identification card of the user.

4. The method of claim 2, wherein the identification information is obtained by a radio frequency identity (RF ID) reader from an RF ID access device of the user.

5. The method of claim 2, wherein the identification information is a passcode entered by the user.

6. The method of claim 2, wherein the identification information is obtained by reading a biometric feature of the user.

7. The method of claim 2, further comprising:
determining an identification of a checked-in portable computing device being returned to one of the bays of the multi-bay charging station;
locking the checked-in portable computing device within the bay to which the portable computing device is being returned; and
performing one of:
recording an indication that the portable computing device has been checked in; or
recording a dissociation of the user and the checked-in portable computing device.

8. The method of claim 7, wherein the identification of the checked-in portable computing device is determined by reading a device ID via a power/data connector through which the checked-in portable computing device is charged.

9. The method of claim 7, wherein the identification of the checked-in portable computing device is determined by receiving a device ID from the checked-in portable computing device via a radio frequency (RF) interface.

10. The method of claim 2, further comprising:
sending the identification information from a first system which obtains the identification of the user to a remote authorization controller via a network which interconnects the first system and the remote authorization controller;
receiving an authorization signal from the remote authorization controller, wherein the authorization signal is generated by the remote authorization controller based on the identification information; and
unlocking the selected portable computing device in response to receiving the authorization signal from the remote authorization controller.

11. The method of claim 10, further comprising:
determining an identification of a checked-in portable computing device being returned to one of the bays of the multi-bay charging station;
locking the checked-in portable computing device within the bay to which the portable computing device is being returned; and
sending identification of the checked-in portable computing device to the remote authorization controller via the network.

12. The method of claim 11, wherein the identification of the checked-in portable computing device is determined by reading a device ID via a power/data connector through which the checked-in portable computing device is charged.

13. The method of claim 12, wherein the identification of the checked-in portable computing device is determined by receiving a device ID from the checked-in portable computing device via a radio frequency (RF) interface.

14. An apparatus for controlling access to each of a plurality of portable computing devices, the apparatus comprising:
an identification information reader for obtaining identification information of a user;
a controller for selecting a portable computing device from the plurality of portable computing devices and recording an association of the user and the selected portable computing device within a database; and
a locking mechanism for locking each of the plurality of portable computing devices and unlocking the selected portable computing device in response to the controller providing an authorization signal.

15. The apparatus of claim 14, wherein the locking mechanism is a multi-bay charging station with each bay including a mechanical lock which is controlled independently of the mechanical lock for each of the other bays.

16. The apparatus of claim 15, wherein the identification information reader is a barcode reader for reading a barcode identifying the user.

17. The apparatus of claim 15, wherein the identification information reader is a radio frequency identity (RF ID) reader for interrogating an RF ID access device and receiving a response identifying the user.

18. The apparatus of claim 15, wherein the identification information reader is a mechanical or virtual keypad for obtaining user entry of a passcode identifying the user.

19. The apparatus of claim 15, wherein the identification information reader is a biometric information reader for reading a biometric feature of the user.

20. The apparatus of claim 15, wherein the apparatus is configured to:
determine an identification of a checked-in portable computing device being returned to one of the bays of the multi-bay charging station;
lock the checked-in portable computing device within the bay to which the checked-in portable computing device is being returned; and
perform one of:
record an indication that the portable computing device has been checked in; or
record a dissociation of the user and the checked-in portable computing device.

21. The apparatus of claim 20, wherein the apparatus is configured to determine the identification of the checked-in portable computing device by reading a device ID via a power/data connector through which the checked-in portable computing device is charged.

22. The apparatus of claim 20, wherein the apparatus is configured to determine the identification of the checked-in portable computing device by receiving a device ID from the checked-in portable computing device via a radio frequency (RF) interface.

23. The apparatus of claim 15, wherein:
the identification information reader is embodied in a first system which further includes a communication interface communicatively coupling the identification information reader to the controller via a network;
the controller is configured to receive an authorization request message comprising the identification information and provide an authorization response message; and
the locking mechanism is configured to unlock the selected portable computing device in response to the authorization response message.

24. The apparatus of claim 23, further comprising, within each bay of the multi-bay charging station, an ultraviolet light for sterilizing the checked-in portable computing device, wherein the ultraviolet light is activated to sterilize the checked-in portable computing device upon it being returned to the bay of the multi-bay charging station.

25. A portable computing device, comprising:
an identification information reader for obtaining user identification information identifying a user;
a network interface for:
sending an authorization request to a remote server, the authorization request comprising identification of the portable computing device and the user identification information; and
receiving an authorization response from the remote server; and
a controller for unlocking the portable computing device based on the authorization response received from the remote server.

26. The portable computing device of claim 25, wherein unlocking the portable computing device comprises sending an unlock signal to a mechanical device securing the portable computing device whereby the mechanical device mechanically releases the portable computing device in response to the unlock signal.

27. The portable computing device of claim 25, wherein the authorization response includes an authorization code and unlocking the portable computing device comprises input of the authorization code to an electronic locking system of the portable computing device, the electronic locking system unlocking the portable computing device to enable use only if the authorization code is a valid authorization code.

28. The portable computing device of claim 27, wherein the controller is configured to lock the portable computing device if the portable computing device is moved beyond a limited area in which the user is authorized to operate the portable computing device.
